(19) United States
(12) Patent Application Publication
(10) Pub. No.: US 2021/0045966 A1
(43) Pub. Date: Feb. 18, 2021

(54) VEHICLE FOOT MASSAGE SYSTEM IN A VEHICLE FLOOR

(71) Applicant: GM GLOBAL TECHNOLOGY OPERATIONS LLC, Detrot, MI (US)

(72) Inventor: Samuel J. Melnyk, Troy, MI (US)

(21) Appl. No.: 16/538,897

(22) Filed: Aug. 13, 2019

(51) Int. Cl. A61H 23/04; B60N 3/06

(52) U.S. Cl. CPC A61H 23/04; B60N 3/06; A61H 2201/164; A61H 2205/12; A61H 2201/1409; A61H 2203/0431

(57) ABSTRACT

A vehicle foot massage system for a vehicle floor includes a plurality of pneumatic elements positioned on the vehicle floor, an air pressure generating device, and a plurality of connecting lines each in communication with one of the plurality of pneumatic elements and with the air pressure generating device.

### FIELD

The present disclosure relates to a vehicle foot massage system in a vehicle floor.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicle seats which include massage systems are available in many configurations. The health benefits of receiving a massage are well known and include relaxation, stress relief, improved circulation, lower blood pressure, alleviation of headaches or migraines, anxiety relief, natural pain relief, along with many other benefits too numerous to list here.

### SUMMARY

In an exemplary aspect, a vehicle foot massage system for a vehicle floor includes a plurality of pneumatic elements positioned on the vehicle floor, an air pressure generating device, and a plurality of connecting lines each in communication with one of the plurality of pneumatic elements and with the air pressure generating device.

In another exemplary aspect, the plurality of pneumatic elements are distributed on the vehicle floor in front of a passenger seat.

In another exemplary aspect, the plurality of pneumatic elements are positioned to correspond to a foot location for a passenger occupying the passenger seat.

In another exemplary aspect, a first group of the plurality of pneumatic elements are positioned relative to each other along a longitudinal axis of the vehicle.

In another exemplary aspect, the first group of the plurality of pneumatic elements are positioned in one of a right side and a left side of the vehicle floor in front of the passenger seat.

In another exemplary aspect, a second group of the plurality of pneumatic elements are positioned in the other of the right side and the left side of the vehicle floor in front of the passenger seat.

In another exemplary aspect, the system further includes an air manifold in communication with the plurality of connecting lines and selectively connecting each of the plurality of the connecting lines to the air pressure generating device.

In another exemplary aspect, the system further includes a controller in communication with the air manifold and adapted to generate an air manifold control signal.

In another exemplary aspect, the air manifold is responsive to the air manifold control signal from the controller to selectively permit air passage through each of the plurality of connecting lines from the air pressure generating device to the plurality of pneumatic elements.

In another exemplary aspect, the system further includes a controller in communication with the air pressure generating device and adapted to selectively generate an air pressure signal.

In another exemplary aspect, the air pressure generating device is responsive to the air pressure signal from the controller to generate air pressure.

In another exemplary aspect, the plurality of pneumatic elements at least partially overlap each other in a longitudinal direction of the vehicle.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of a vehicle including a vehicle foot massage system in accordance with an exemplary embodiment of the present disclosure;

FIG. 2 is a schematic plan view of a vehicle foot massage system in accordance with an exemplary embodiment of the present disclosure;

FIG. 3 is a schematic plan view of a vehicle foot massage system in accordance with another exemplary embodiment of the present disclosure; and

FIG. 4 is a schematic illustration of a vehicle foot massage system in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

The inventor of the present disclosure understands the many benefits of massage and developed a vehicle foot massage system which is incorporated into a vehicle floor.

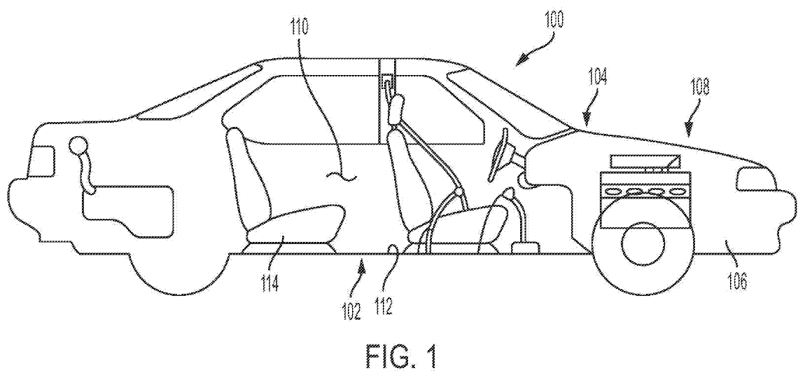

Referring now to the drawings, wherein like reference numbers correspond to like or similar components throughout the several figures, FIG. 1 is a schematic illustration of a vehicle 100 with a vehicle foot massage system 102 in accordance with an exemplary embodiment of the present disclosure. The vehicle 100 includes a chassis 104 and a body 106 supported by the chassis 104. As shown, the body 106 includes a motor compartment 108 and a passenger compartment 110. The vehicle foot massage system 102 may be positioned in a floor area 112 in front of a passenger seat 114 in the vehicle 100.

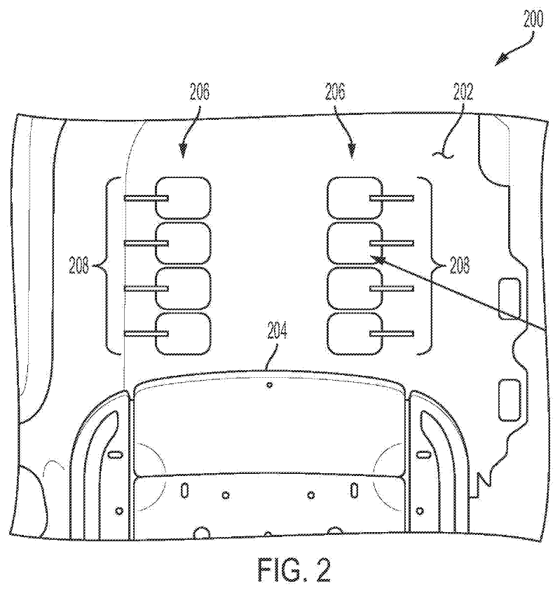

Referring now to FIG. 2 is a schematic plan view of a portion of a vehicle foot massage system 200 in accordance with an exemplary embodiment of the present disclosure. As illustrated, the vehicle foot massage system 200 may be positioned in a floor area 202 in front of a passenger seat 204 in a vehicle. The vehicle foot massage system 200 includes a plurality of pressurizable elements or pneumatic elements 206 which may be actuated with air pressure by a pressure generating device (not shown) via respective connecting lines 208. The pneumatic elements 206 may be arranged in the floor area 202 such that a first group of the plurality of pneumatic elements 206 may be located in a left side of the floor area 202 and the remainder of the plurality of pneumatic elements 206 may be located in a right side of the floor area 202 such that an occupant of the passenger seat 204 may easily position their feet onto corresponding pneumatic elements 206, respectively. In the exemplary embodiment of FIG. 2, each half of the plurality of pneumatic elements 206 are aligned in an array having an axis roughly aligned in a direction of the vehicle such that they will align with the passenger feet respectively positioned on the pneumatic elements 206. The pneumatic elements 206 may be positioned on a vehicle floor beneath the vehicle carpet and/or may be incorporated into a selectively connectable floor mat.

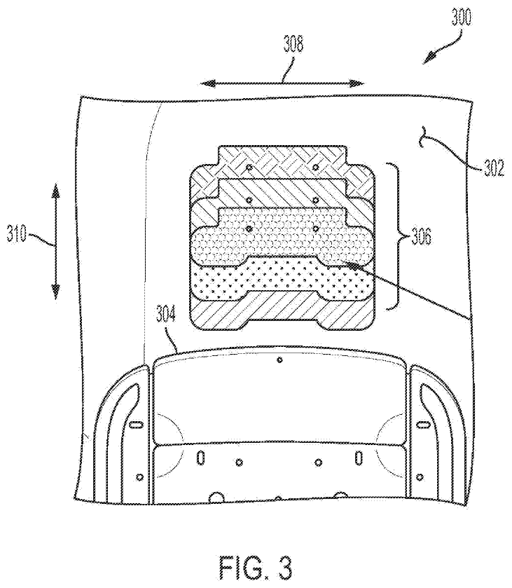

FIG. 3 is a schematic plan view of a portion of another vehicle foot massage system 300 in accordance with another exemplary embodiment of the present disclosure. As illustrated, the vehicle foot massage system 300 may be positioned in a floor area 302 in front of a passenger seat 304 in a vehicle. The vehicle foot massage system 300 includes a plurality of pressurizable elements or pneumatic elements 306 which may be actuated with air pressure by a pressure generating device (not shown) via respective connecting lines (not shown). The vehicle foot massage system 300 includes three pneumatic elements 306 which extend a lateral direction 308 and at least partially overlap each other in a longitudinal direction 310. The extent by which the pneumatic elements 306 extend in the lateral direction 308 may approximate the lateral direction which a passenger occupant's feet may be spaced in the lateral direction 308 when occupying the passenger seat 304.

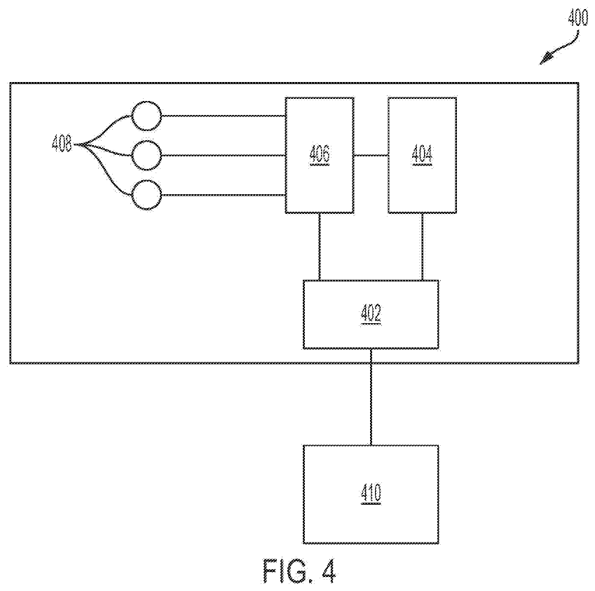

FIG. 4 is a schematic illustration of a vehicle foot massage system 400 in accordance with the present disclosure. The vehicle foot massage system 400 includes a controller 402, an air pump 404, an air manifold 406, and a plurality of pneumatic elements 408. The controller 402 may communicate with a vehicle user interface 410 to receive instructions from a vehicle occupant. In response, the controller 402 may control operation of the air pump 404 to selectively provide a source of pressurized air and of the air manifold 406 to selectively provide pressurized air to the pneumatic elements 408. The user interface 410 may include, for example, a display screen (not shown) with which a vehicle occupant may select from a plurality of massage patterns which determine the pattern of operation of the vehicle foot massage system. Further, the controller 402 may be adapted to carry out a plurality of preset and individually settable massage functions.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle foot massage system for a vehicle floor, the system comprising:
a plurality of pneumatic elements positioned on the vehicle floor;
an air pressure generating device; and
a plurality of connecting lines each in communication with one of the plurality of pneumatic elements and with the air pressure generating device.

2. The system of claim 1, wherein the plurality of pneumatic elements are distributed on the vehicle floor in front of a passenger seat.

3. The system of claim 2, wherein the plurality of pneumatic elements are positioned to correspond to a foot location for a passenger occupying the passenger seat.

4. The system of claim 3, wherein a first group of the plurality of pneumatic elements are positioned relative to each other along a longitudinal axis of the vehicle.

5. The system of claim 4, wherein the first group of the plurality of pneumatic elements are positioned in one of a right side and a left side of the vehicle floor in front of the passenger seat.

6. The system of claim 5, wherein a second group of the plurality of pneumatic elements are positioned in the other of the right side and the left side of the vehicle floor in front of the passenger seat.

7. The system of claim 1, further comprising an air manifold in communication with the plurality of connecting lines and selectively connecting each of the plurality of the connecting lines to the air pressure generating device.

8. The system of claim 7, further comprising a controller in communication with the air manifold and adapted to generate an air manifold control signal.

9. The system of claim 8, wherein the air manifold is responsive to the air manifold control signal from the controller to selectively permit air passage through each of the plurality of connecting lines from the air pressure generating device to the plurality of pneumatic elements.

10. The system of claim 1, further comprising a controller in communication with the air pressure generating device and adapted to selectively generate an air pressure signal.

11. The system of claim 10, wherein the air pressure generating device is responsive to the air pressure signal from the controller to generate air pressure.

12. The system of claim 1, wherein the plurality of pneumatic elements at least partially overlap each other in a longitudinal direction of the vehicle.

13. A vehicle with a vehicle foot massage system on a floor of the vehicle, the vehicle comprising:
a body including a vehicle floor and defining a passenger compartment;
a passenger seat positioned within the passenger compartment on the vehicle floor;
a plurality of pneumatic elements positioned on the vehicle floor in front of the passenger seat;
a plurality of connecting lines each in communication with one of the plurality of pneumatic elements;
an air pressure generating device;
an air manifold in communication with the plurality of connecting lines and the air pressure generating device to selectively each of the plurality of connecting lines to the air pressure generating device; and
a controller in communication with the air manifold and the air pressure generating device, adapted to generate an air manifold control signal, and adapted to selectively generate an air pressure signal, wherein the air manifold is responsive to the air manifold control signal from the controller to selectively permit air passage through each of the plurality of connecting lines from the air pressure generating device to the plurality of pneumatic elements, wherein the air pressure generating device is responsive to the air pressure signal from the controller to generate air pressure, wherein a first group of the plurality of pneumatic elements are positioned relative to each other along a longitudinal axis of the vehicle, wherein the first group of the plurality of pneumatic elements are positioned in one of a right side and a left side of the vehicle floor in front of the passenger seat, and wherein a second group of the plurality of pneumatic elements are positioned in the other of the right side and the left side of the vehicle floor in front of the passenger seat.

14. A vehicle with a vehicle foot massage system on a floor of the vehicle, the vehicle comprising:
a body including a vehicle floor and defining a passenger compartment;
a passenger seat positioned within the passenger compartment on the vehicle floor;
a plurality of pneumatic elements positioned on the vehicle floor in front of the passenger seat;
a plurality of connecting lines each in communication with one of the plurality of pneumatic elements;
an air pressure generating device;
an air manifold in communication with the plurality of connecting lines and the air pressure generating device to selectively each of the plurality of connecting lines to the air pressure generating device; and
a controller in communication with the air manifold and the air pressure generating device, adapted to generate an air manifold control signal, and adapted to selectively generate an air pressure signal, wherein the air manifold is responsive to the air manifold control signal from the controller to selectively permit air passage through each of the plurality of connecting lines from the air pressure generating device to the plurality of pneumatic elements, wherein the air pressure generating device is responsive to the air pressure signal from the controller to generate air pressure, and wherein the plurality of pneumatic elements at least partially overlap each other in a longitudinal direction of the vehicle.
